(19) United States
(12) Patent Application Publication
(10) Pub. No.: US 2019/0381930 A1
(43) Pub. Date: Dec. 19, 2019

(54) Article for Securing Items in Moving Vehicles

(71) Applicant: Leonard Bankhead, Wyandotte, MI (US)

(72) Inventor: Leonard Bankhead, Wyandotte, MI (US)

(21) Appl. No.: 16/011,424

(22) Filed: Jun. 18, 2018

(51) Int. Cl. B60P 7/135

(52) U.S. Cl. CPC B60P 7/135

(57) ABSTRACT

Disclosed herein are device embodiments for securing items during operation of a moving vehicle. A cargo-barrier device comprises a block having a prism shape with one or more pieces of hook and loop material in a bottom face of the shape. The prism shape comprises a first four-sided polygonal base and a second base comprising a translated copy of the first base, wherein a long side of the four sides is longer than an opposing side. The shape further includes four faces joining corresponding sides of the first and second bases.

### BACKGROUND

### Technical Field

Embodiments generally relate to an article for securing items from movement damage in vehicles.

### Background

A common inconvenience when transporting items by vehicle is the potential for fragile items to tip over, roll around, or smash into other items during operation of the vehicle. For example, grocery shoppers may find their bottles, bread or eggs damaged if they are not careful while driving or positioning items in a car trunk. Current solutions to this problem include using baskets, nets, or strategically pinning items against each to minimize movement and impact. These solutions may prove burdensome to some people as they either require unwanted effort, or permanently occupying large amounts of vehicle space with securing means.

### SUMMARY

Disclosed herein are device embodiments for securing items during operation of a moving vehicle. An cargo-barrier device comprises a block having a prism shape with one or more pieces of hook and loop material in a bottom face of the shape. The prism shape comprises a first four-sided polygonal base and a second base comprising a translated copy of the first base, wherein a long side of the four sides is longer than an opposing side. The shape further includes four faces joining corresponding sides of the first and second bases, the four faces disposed perpendicularly to the first and second bases.

### BRIEF DESCRIPTION OF THE DRAWINGS

The accompanying drawings are incorporated herein and form a part of the specification.

FIG. 1 is illustrates an example embodiment of a cargo barrier device inside the cargo area of a vehicle.

FIG. 2 illustrates perspective view of a cargo barrier device, according to an example embodiment.

FIG. 3 illustrates perspective view showing the bottom of a cargo barrier device having hook and loop fabric, according to an example embodiment.

### DETAILED DESCRIPTION

Provided herein are device embodiments for securing items during operation of a moving vehicle.

While the embodiments described herein are exemplified in the context of the trunk of a car, they are generally applicable to any moving vehicle compartment.

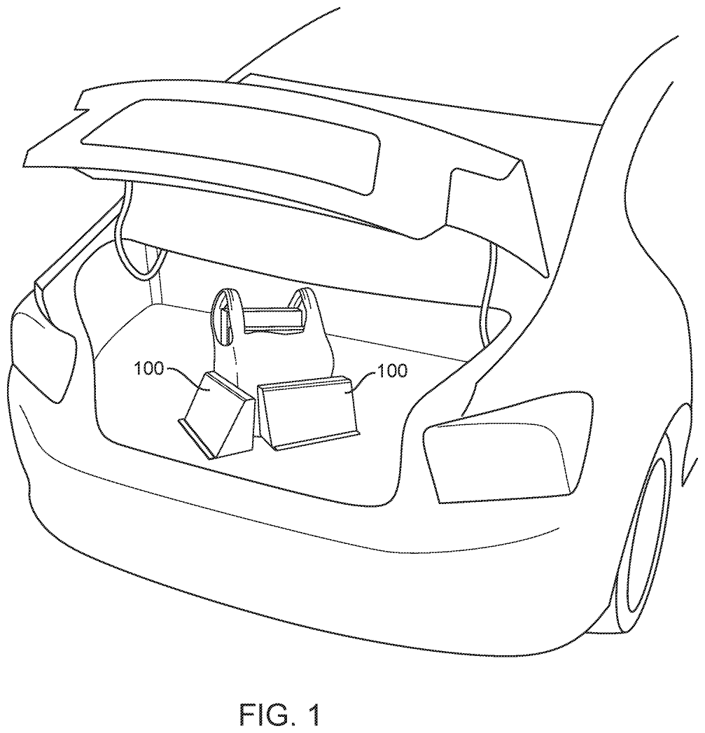

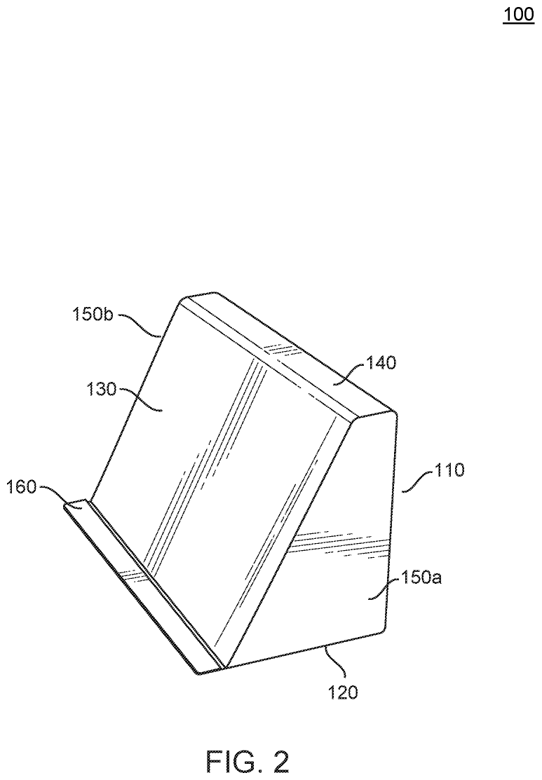

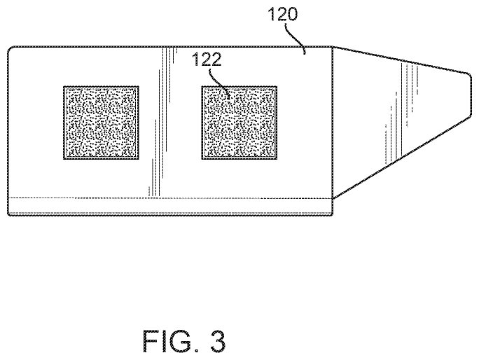

FIGS. 1 and 2 illustrate cargo barrier device 100 for securing items during operation of a moving vehicle, according to an example embodiment. Cargo barrier 100 comprises a back wall 110, a base 120, a support wall 130, a top wall 140 and side walls 150a and 150b. One or more pieces of hook and loop fabric 122 (e.g., Velcro®) may be attached to base 120, as shown in FIG. 3.

FIG. 1 shows an example use of the cargo barrier device 100. A user may position one or more barrier 100 as needed around cargo items in moving vehicle to help reduce their motion during travel. As shown in FIG. 1, a user may pin grocery bags between a barrier 100 and another barrier 100. Barrier 100 may also be used to pin cargo items against walls of the cargo area, such as the sides and back of a car trunk.

As shown in the figures, example device 100 comprises a block having a prism shape comprised of a four-sided polygonal base (side wall 150a). A long side (adjacent to base 120) of the four sides is longer than an opposing side (adjacent to top wall 150). A second base (side wall 150b) is a translated copy of the first base (150a). Four faces (110, 120, 130, 140) of the prism join corresponding sides of the first and second bases, the four faces disposed perpendicularly to the first and second bases, wherein a bottom face (base 120) of the four faces comprises a piece of hook and loop material, the bottom face corresponding to the long side of the four sides.

Hook and loop 122 may serve to maintain barrier 100 in place. As an example, many vehicles have interior carpeting in their cargo areas, the carpeting suitable to securely attach to hook and loop fabric 122 and keep the barrier in place. Fabric 122 may also be attached to a corresponding hook and loop fabric 122, for example, a hook and loop fabric adhered to the floor or walls of a cargo area.

Back wall 110 and base 120 are substantially perpendicular to one another, while support wall 130 extends diagonally from top wall 140 to an opposite end of base 120. In this manner, support wall 130 may add stability against force applied horizontally by a cargo item from back wall 110 towards support wall 130. The support wall in combination with the friction created by hook and loop fabric 122 maintain cargo barrier device 110 in place when positioned against cargo items in movement. Furthermore, if force is applied horizontally from the support wall towards the back wall, the incline in the support wall transfers a portion of the force towards the base, thus increasing the friction between the base and the cargo floor and helping maintain the block in place.

Cargo barrier device 100 may be surrounded by a protective layer, such as a layer made of cloth, plastic, leather, etc. The protective layer may be sewn around the barrier, and may be double stitched forming a flap 160 for increased durability and sturdiness.

The interior of cargo barrier device 100 may be comprised of any suitable material or combination of materials that substantially maintains the shape of the device as described herein. In particular embodiments, the material is a lightweight material, providing the benefit of portability and not adding substantial weight to the vehicle cargo. As an example, the material may be a foam-like or sponge-like material. In particular embodiments, the interior space of device 100 is hollow, and the shape is maintained through solid walls made of any suitable material, such as, by way of example, plastic, metal, wood, cardboard, etc.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

1. A cargo-barrier device comprising:
a block of foam material surrounded by a protective layer, the block having a prism shape, the prism shape comprising,
a first four-sided polygonal base and a second base comprising a translated copy of the first base, wherein a long side of the four sides is longer than an opposing side, and
four faces joining corresponding sides of the first and second bases, the four faces disposed perpendicularly to the first and second bases, wherein a back face extends perpendicularly from a first end of a top face to a first end of a bottom face and a support wall extends at an angle from a second end of the top face to a second end of the bottom face, and wherein the bottom face of the four faces comprises a piece of hook and loop material, the bottom face corresponding to the long side of the four sides.

2. (canceled)

3. The device of claim 2, wherein the protective layer comprises a protective clothe and stitching around the exterior of the block.

4. The device of claim 2, wherein the protective layer comprises a protective plastic and stitching around the exterior of the block.

5. (canceled)

6. The device of claim 1, wherein an interior of the block is hollow.
